(19) United States
(12) Patent Application Publication
(10) Pub. No.: US 2017/0077493 A1
(43) Pub. Date: Mar. 16, 2017

(54) METHOD FOR FORMING POSITIVE ELECTRODE FOR THIN FILM LITHIUM-ION RECHARGEABLE BATTERY, POSITIVE ELECTRODE FOR THIN FILM LITHIUM-ION RECHARGEABLE BATTERY, AND THIN FILM LITHIUM-ION RECHARGEABLE BATTERY

(71) Applicant: ULVAC, INC., Kanagawa (JP)

(72) Inventors: Shunsuke SASAKI, Chigasaki-shi (JP); Akiyoshi SUZUKI, Chigasaki-shi (JP); Takehito JINBO, Chigasaki-shi (JP); Masaki TSUSHIMA, Chigasaki-shi (JP); Kazutoshi TAKAHASHI, Chigasaki-shi (JP)

(21) Appl. No.: 15/260,216

(22) Filed: Sep. 8, 2016

(30) Foreign Application Priority Data
Sep. 14, 2015 (JP) 2015-180882

(51) Int. Cl. H01M 4/131; H01M 4/04; H01M 4/36; H01M 4/525; H01M 4/66; H01M 10/0562; H01M 10/0585; H01M 4/134; H01M 4/38; H01M 4/1391; H01M 10/0525

(52) U.S. Cl. CPC H01M 4/131; H01M 4/1391; H01M 4/0404; H01M 4/0471; H01M 4/366; H01M 4/525; H01M 10/0525; H01M 10/0562; H01M 10/0585; H01M 4/134; H01M 4/382; H01M 4/661; H01M 2004/028

(57) ABSTRACT

A method for forming a positive electrode for a thin film lithium-ion rechargeable battery includes forming a positive electrode power collection layer, forming a first positive electrode active material layer by covering the positive electrode power collection layer with a first positive electrode active material that contains lithium cobalt oxide, forming a second positive electrode active material layer that has a thickness of 20 nm or greater and 60 nm or less by covering the first positive electrode active material layer with a second positive electrode active material that contains aluminum and lithium cobalt oxide, and heating a lamination body that includes the positive electrode power collection layer, the first positive electrode active material layer, and the second positive electrode active material layer.

### CROSS-REFERENCE TO RELATED APPLICATIONS

This application is based upon and claims the benefit of priority from prior Japanese Patent Application No. 2015-180882, filed on Sep. 14, 2015, the entire contents of which are incorporated herein by reference.

### TECHNICAL FIELD

This disclosure relates to a method for forming a positive electrode for a thin film lithium-ion rechargeable battery, a positive electrode for a thin film lithium-ion rechargeable battery, and a thin film lithium-ion rechargeable battery.

### BACKGROUND ART

In a widely used lithium-ion rechargeable battery, lithium ions conduct electricity in the electrolyte, which is located between the positive electrode and the negative electrode. One type of a known lithium-ion rechargeable battery is an all-solid-state thin film lithium-ion rechargeable battery in which the components of the lithium-ion rechargeable battery are all solid. Japanese Laid-Open Patent Publication No. 2013-105708 describes a prior art example of an all-solid-state thin film lithium-ion rechargeable battery. The all-solid-state thin film lithium-ion rechargeable battery does not need a flammable organic solvent as the electrolyte. This increases safety of the rechargeable battery as compared to a lithium-ion rechargeable battery that includes a liquid electrolyte.

### SUMMARY

The output density is one index that indicates the performance of the thin film lithium-ion rechargeable battery. The output density is expressed by the product of the discharge current and the discharge voltage and specified per unit weight or per unit volume. To reduce the size of the thin film lithium-ion rechargeable battery, the output density needs to be increased. In other words, there is a need to increase the discharge voltage when the discharge current is the maximum.

One embodiment is a method for forming a positive electrode for a thin film lithium-ion rechargeable battery. The method includes forming a positive electrode power collection layer, forming a first positive electrode active material layer by covering the positive electrode power collection layer with a first positive electrode active material that contains lithium cobalt oxide, forming a second positive electrode active material layer that has a thickness of 20 nm or greater and 60 nm or less by covering the first positive electrode active material layer with a second positive electrode active material that contains aluminum and lithium cobalt oxide, and heating a lamination body that includes the positive electrode power collection layer, the first positive electrode active material layer, and the second positive electrode active material layer.

Another embodiment is a positive electrode for a thin film lithium-ion rechargeable battery. The positive electrode for a thin film lithium-ion rechargeable battery includes a positive electrode power collection layer including a cover surface, a first positive electrode active material layer formed from a first positive electrode active material that contains lithium cobalt oxide, and a second positive electrode active material layer formed from a second positive electrode active material that contains aluminum and lithium cobalt oxide. The first positive electrode active material layer includes a first surface, which faces the cover surface of the positive electrode power collection layer, and a second surface, which is opposite to the first surface. The second positive electrode active material layer has a thickness of 40 nm or greater and 80 nm or less and covers and contacts the second surface of the first positive electrode active material layer.

A further embodiment is a thin film lithium-ion rechargeable battery. The thin film lithium-ion rechargeable battery includes the above positive electrode, a negative electrode, and a solid electrolyte layer located between the positive electrode and the negative electrode. The first positive electrode active material layer and the second positive electrode active material layer are located between the positive electrode power collection layer and the solid electrolyte layer.

Other embodiments and advantages thereof will become apparent from the following description, taken in conjunction with the accompanying drawings, illustrating by way of example the principles of this disclosure.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic cross-sectional view illustrating one embodiment of a thin film lithium-ion rechargeable battery.

FIG. 2 is a cross-sectional view illustrating a step of forming a positive electrode power collection layer in a method for manufacturing the thin film lithium-ion rechargeable battery illustrated in FIG. 1.

FIG. 3 is a cross-sectional view illustrating a step of forming a first positive electrode active material layer in the method for manufacturing the thin film lithium-ion rechargeable battery illustrated in FIG. 1.

FIG. 4 is a cross-sectional view illustrating a step of forming a second positive electrode active material layer in the method for manufacturing the thin film lithium-ion rechargeable battery illustrated in FIG. 1.

FIG. 5 is a cross-sectional view illustrating a heating step in the method for manufacturing the thin film lithium-ion rechargeable battery illustrated in FIG. 1.

FIG. 6 is a cross-sectional view illustrating a step of forming a solid electrolyte layer in the method for manufacturing the thin film lithium-ion rechargeable battery illustrated in FIG. 1.

FIG. 7 is a graph of Raman spectrums obtained in a first test and a second test.

FIG. 8 is an SEM image of a third test captured by a scanning electron microscope.

FIG. 9 is an SEM image of a fourth test captured by a scanning electron microscope.

FIG. 10 is a Cole-Cole plot diagram illustrating the measurement results of internal resistances of a fifth test and a sixth test obtained through an AC impedance process.

FIG. 11 is a graph illustrating the relationship between the thickness and the internal resistance of the second positive electrode active material layer.

FIG. 12 is a graph illustrating the relationship between the thickness and the discharge voltage of the second positive electrode active material layer and the relationship between the thickness and the discharge capacity of the second positive electrode active material layer.

FIG. 13 is an image illustrating the measurement result of X-ray intensities obtained using an STEM-EDX.

### DESCRIPTION OF THE EMBODIMENTS

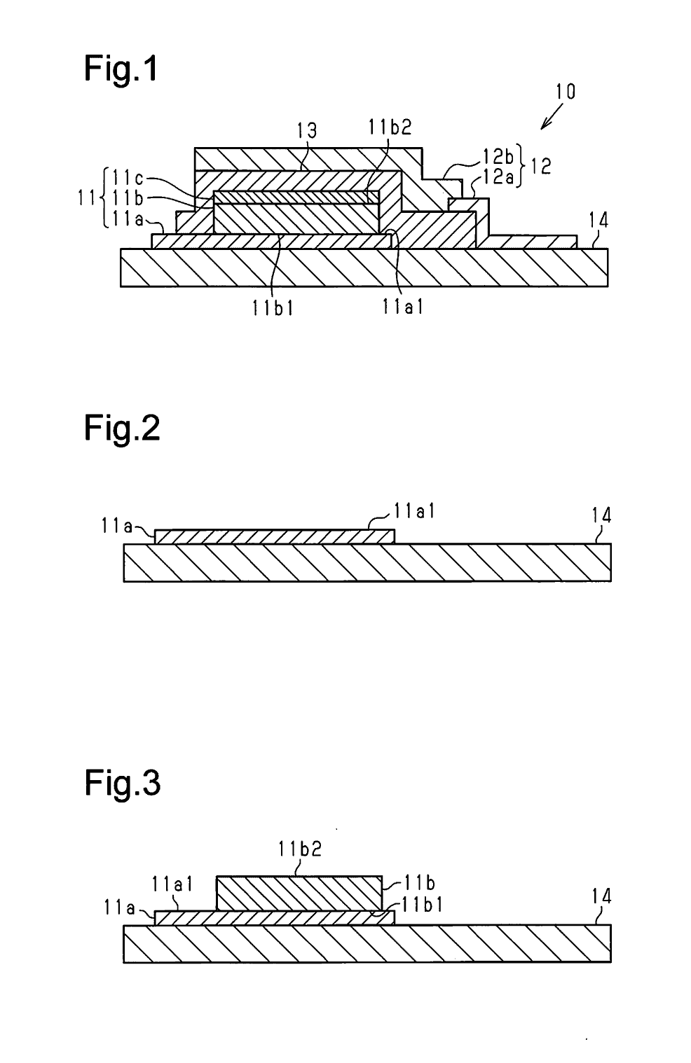

Embodiments of a method for forming a positive electrode for a thin film lithium-ion rechargeable battery, a positive electrode for a thin film lithium-ion rechargeable battery, and a thin film lithium-ion rechargeable battery will now be described with reference to FIGS. 1 to 13. Elements in the drawings may be partially enlarged for simplicity and clarity and thus have not necessarily been drawn to scale.

[Structure of Thin Film Lithium-Ion Rechargeable Battery]

The structure of a thin film lithium-ion rechargeable battery 10 will now be described with reference to FIG. 1. As illustrated in FIG. 1, the thin film lithium-ion rechargeable battery 10 includes a positive electrode 11, which is an example of a positive electrode for a thin film lithium-ion rechargeable battery, a negative electrode 12, and a solid electrolyte layer 13, which is located between the positive electrode 11 and the negative electrode 12.

The positive electrode 11 includes a positive electrode power collection layer 11a, a first positive electrode active material layer 11b, and a second positive electrode active material layer 11c. The positive electrode power collection layer 11a includes a cover surface 11a1. The first positive electrode active material layer 11b includes a first surface 11b1, which faces the cover surface 11a1 of the positive electrode power collection layer 11a, and a second surface 11b2, which is opposite to the first surface 11b1. The first positive electrode active material layer 11b is formed from a first positive electrode active material that contains lithium cobalt oxide (LiCoO₂) as the main component.

The second positive electrode active material layer 11c is formed from a second positive electrode active material that contains aluminum and lithium cobalt oxide. The main component of the second positive electrode active material layer 11c is a material in which cobalt of lithium cobalt oxide is partially replaced with aluminum. The material is expressed by a composition formula of LiCo₁₋ₓAlₓO₂. The thickness of the second positive electrode active material layer 11c is 40 nm or greater and 80 nm or less. The second positive electrode active material layer 11c covers and contacts the second surface 11b2 of the first positive electrode active material layer 11b. When the thickness of the second positive electrode active material layer 11c is 40 nm or greater and 80 nm or less, the output density of the thin film lithium-ion rechargeable battery 10 is increased.

In the thin film lithium-ion rechargeable battery 10, the first positive electrode active material layer 11b and the second positive electrode active material layer 11c of the positive electrode 11 are located between the positive electrode power collection layer 11a and the solid electrolyte layer 13.

The thin film lithium-ion rechargeable battery 10 includes a plate 14, on which the positive electrode 11, the negative electrode 12, and the solid electrolyte layer 13 are formed. The material forming the plate 14 only needs to be, for example, glass, ceramic, or resin.

The positive electrode power collection layer 11a is formed on a surface of the plate 14. The positive electrode power collection layer 11a is, for example, a lamination film obtained by forming a platinum film on a titanium film.

The solid electrolyte layer 13 covers the first positive electrode active material layer 11b and the second positive electrode active material layer 11c. The solid electrolyte layer 13 is formed from, for example, lithium phosphorus oxynitride (LiPON). The solid electrolyte layer 13 does not need to cover both of the first positive electrode active material layer 11b and the second positive electrode active material layer 11c as long as the solid electrolyte layer 13 includes a surface that is in contact with at least the second positive electrode active material layer 11c.

The negative electrode 12 includes a negative electrode power collection layer 12a and a negative electrode active material layer 12b. The negative electrode active material layer 12b substantially covers the entire surfaces of the solid electrolyte layer 13 located at the side opposite to the side of the surfaces contacting the positive electrode 11. The negative electrode power collection layer 12a is in contact with the solid electrolyte layer 13 and the negative electrode active material layer 12b. The negative electrode power collection layer 12a is, for example, a lamination film obtained by forming a nickel film on a chromium film. The material forming the negative electrode active material layer 12b is, for example, lithium.

In the thin film lithium-ion rechargeable battery 10, the material forming the positive electrode power collection layer 11a, the material forming the solid electrolyte layer 13, and the material forming the negative electrode 12 may be a different metal or a different metal alloy that fulfills the function of each component.

[Manufacturing Method of Thin Film Lithium-Ion Rechargeable Battery]

A method for manufacturing the thin film lithium-ion rechargeable battery 10 will now be described with reference to FIGS. 2 to 6.

The method for manufacturing the thin film lithium-ion rechargeable battery 10 includes a method for forming the positive electrode 11 for the thin film lithium-ion rechargeable battery 10. The method for forming the positive electrode 11 includes forming the positive electrode power collection layer 11a, forming the first positive electrode active material layer 11b, forming the second positive electrode active material layer 11c, and heating a lamination body that forms the positive electrode 11.

In the present example, a step of forming the first positive electrode active material layer 11b includes forming the first positive electrode active material layer 11b by covering the positive electrode power collection layer 11a with the first positive electrode active material, which contains lithium cobalt oxide.

In the present example, a step of forming the second positive electrode active material layer 11c includes forming the second positive electrode active material layer 11c that has a thickness of 20 nm or greater and 60 nm or less by covering the first positive electrode active material layer 11b with the second positive electrode active material, which contains aluminum and lithium cobalt oxide. A step of heating the lamination body includes heating the lamination body that includes the positive electrode power collection layer 11a, the first positive electrode active material layer 11b, and the second positive electrode active material layer 11c. The heating step is performed, for example, in an annealing step.

The method for manufacturing the thin film lithium-ion rechargeable battery 10 will now be further specifically described.

As illustrated in FIG. 2, the positive electrode power collection layer 11a is formed on a surface of the plate 14. The positive electrode power collection layer 11a includes the cover surface 11a1, which is opposite to the surface that is in contact with the plate 14. The positive electrode power collection layer 11a is formed, for example, by a lamination film of a titanium film and a platinum film. In this case, a target formed by titanium and a target formed by platinum are sequentially sputtered to form the positive electrode power collection layer 11a.

As illustrated in FIG. 3, the first positive electrode active material layer 11b is formed to cover the positive electrode power collection layer 11a. More specifically, the first positive electrode active material layer 11b is laminated on the positive electrode power collection layer 11a. The first positive electrode active material layer 11b includes a first surface 11b1, which is in contact with the cover surface 11a 1 of the positive electrode power collection layer 11a, and a second surface 11b2, which is opposite to the first surface 11b1. In the present example, a target formed by lithium cobalt oxide is sputtered to form the first positive electrode active material layer 11b that has a thickness of, for example, 1 μm or greater and 60 μm or less. At this time, the main component of the first positive electrode active material layer 11b is the amorphous first positive electrode active material.

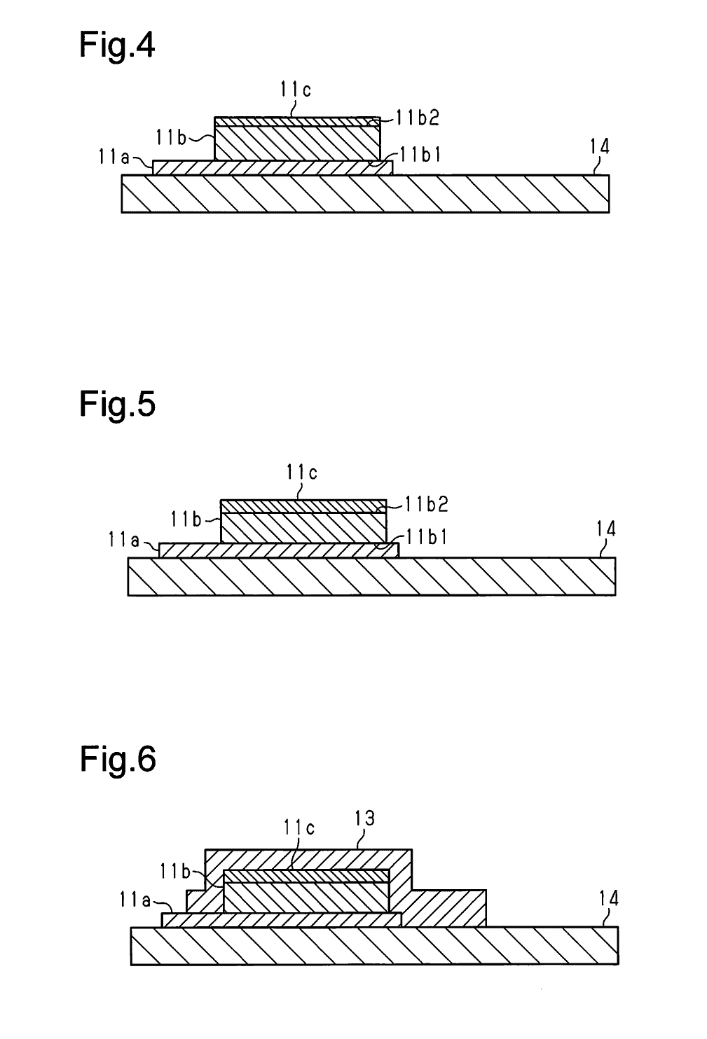

As illustrated in FIG. 4, the second positive electrode active material layer 11c is formed to cover the second surface 11b2 of the first positive electrode active material layer 11b. More specifically, the second positive electrode active material layer 11c is laminated on the first positive electrode active material layer 11b. In the present example, a target that is formed by a material having a composition in which cobalt of lithium cobalt oxide is partially replaced with aluminum is sputtered to form the second positive electrode active material layer 11c. At this time, the main component of the second positive electrode active material layer 11c is the amorphous second positive electrode active material.

In the present example, the step of forming the second positive electrode active material layer 11c forms the second positive electrode active material layer 11c that has a thickness of 20 nm or greater and 60 nm or less. When the second positive electrode active material layer 11c, which covers the first positive electrode active material layer 11b, is formed to have the thickness of 20 nm or greater and 60 nm or less, the output density of the thin film lithium-ion rechargeable battery 10 is increased.

In the step of forming the second positive electrode active material layer 11c, it is preferred that the second positive electrode active material layer 11c be formed to have a thickness of 20 nm or greater and 30 nm or less. The second positive electrode active material layer 11c having the thickness of 20 nm or greater and 30 nm or less increases the output density of the thin film lithium-ion rechargeable battery 10 and limits decreases in the discharge capacity of the thin film lithium-ion rechargeable battery 10.

When the total of the number of aluminum atoms and the number of cobalt atoms is set to one, it is preferred that the second positive electrode active material layer 11c be formed so that the number of aluminum atoms is 0.05 or greater and less than 0.5.

Namely, it is preferred in LiCo₁₋ₓAlₓO₂, which is the composition formula of the main component of the second positive electrode active material layer 11c, that 0.05≦x<0.5. When the number of aluminum atoms contained in the second positive electrode active material satisfies x≧0.05, the second positive electrode active material has a higher thermal resistance than the first positive electrode active material. Also, when the number of aluminum atoms contained in the second positive electrode active material satisfies x<0.5, the crystal structure of the second positive electrode active material layer 11c does not differ greatly from that of the first positive electrode active material layer 11b.

The main component of a target forming the second positive electrode active material layer 11c is a material having a composition in which cobalt of lithium cobalt oxide is partially replaced with aluminum. For example, the material expressed by the composition formula of LiCo_{0.9}Al_{0.1}O₂ is preferred. The second positive electrode active material layer 11c may be formed by simultaneously sputtering the target formed by lithium cobalt oxide and the target formed by aluminum.

The lamination body that includes the positive electrode power collection layer 11a, the first positive electrode active material layer 11b, and the second positive electrode active material layer 11c is heated. In the heating step, the lamination body is heated, for example, at 580° C. for ten minutes. Consequently, the first positive electrode active material layer 11b and the second positive electrode active material layer 11c, each of which is amorphous, are heated and crystallized.

Referring to FIG. 5, when the lamination body is heated, aluminum atoms and cobalt atoms perform counter diffusion at an interface of the first positive electrode active material layer 11b and the second positive electrode active material layer 11c, that is, contact surfaces of the second surface 11b2 of the first positive electrode active material layer 11b and the second positive electrode active material layer 11c. At this time, the inventors of the present application confirmed that aluminum atoms were diffused from the second positive electrode active material layer 11c into the first positive electrode active material layer 11b to a depth of 20 nm from the position of the interface (second surface 11b2) located prior to the heating. Such diffusion of aluminum atoms increases the thickness of the second positive electrode active material layer 11c subsequent to the heating (refer to FIG. 5) as compared to that prior to the heating (refer to FIG. 4). In the present example, the heating is performed so that the second positive electrode active material layer 11c has the thickness of 40 nm or greater and 80 nm or less.

As illustrated in FIG. 6, the solid electrolyte layer 13 is formed to cover the first positive electrode active material layer 11b and the second positive electrode active material layer 11c. The solid electrolyte layer 13 is formed, for example, by sputtering a target formed by lithium phosphate in a nitrogen plasma atmosphere.

Then, the negative electrode power collection layer 12a and the negative electrode active material layer 12b are sequentially formed to obtain the thin film lithium-ion rechargeable battery 10 illustrated in FIG. 1. The negative electrode power collection layer 12a is formed, for example, by a lamination film of a chromium film and a nickel film. In this case, the negative electrode power collection layer 12a is formed by sequentially sputtering a target formed by chromium and a target formed by nickel. The material of the negative electrode active material layer 12b is, for example, lithium. In this case, the negative electrode active material layer 12b is formed, for example, by heating a lithium piece in a vacuum chamber and performing lithium vapor deposition on a structural body that includes the negative electrode power collection layer 12a.

[Tests]

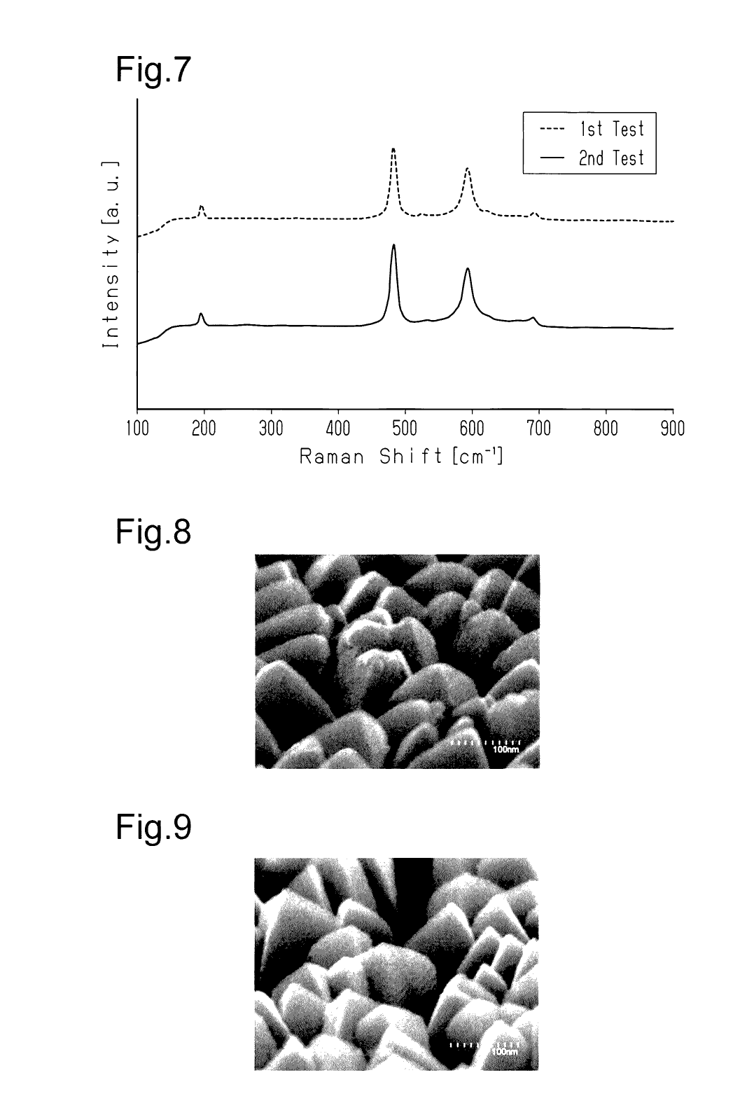

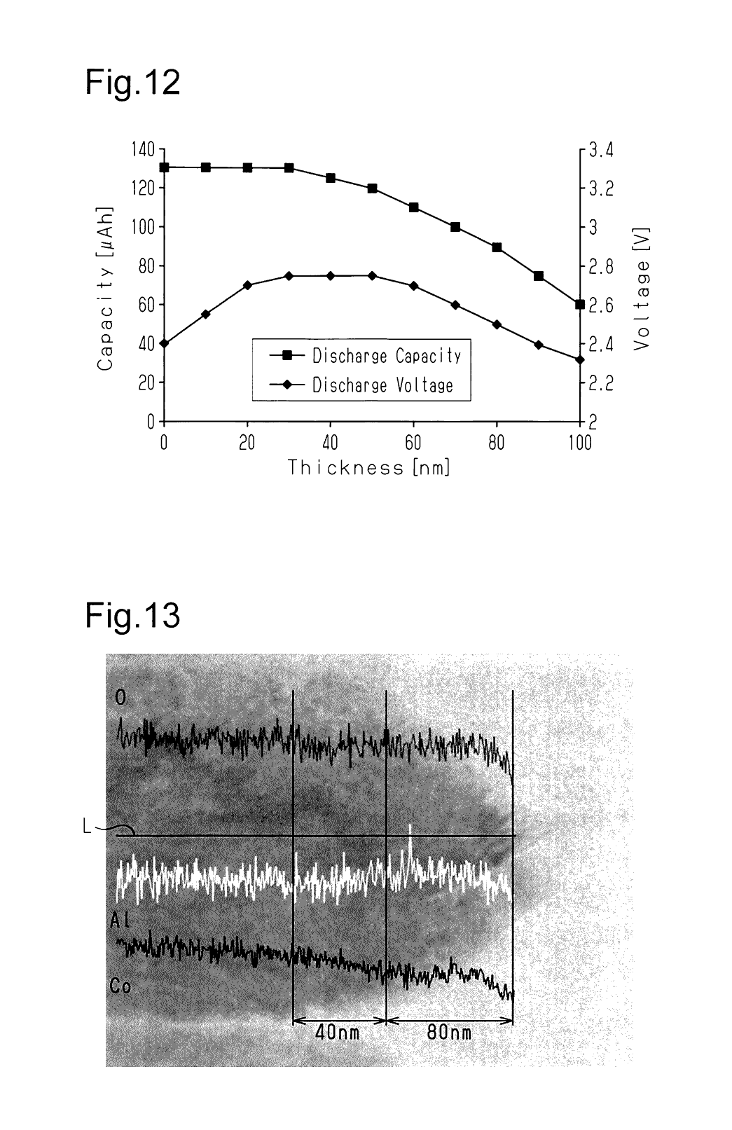

Various embodiments will now be described with reference to FIGS. 7 to 13. FIGS. 11 and 12 illustrate the thickness of the second positive electrode active material layer 11c prior to the heating. FIG. 13 illustrates the thickness of the second positive electrode active material layer 11c subsequent to the heating. In the description hereafter, to facilitate understanding, the same reference characters are given to those elements that are the same as the corresponding elements illustrated in FIGS. 1 to 6.

[Raman Spectroscopic Analysis]

The first positive electrode active material layer 11b formed by lithium cobalt oxide and having a thickness of 3 μm was formed on a surface of the plate 14. Then, the first positive electrode active material layer 11b was heated at 580° C. for ten minutes. This obtained a test piece of a first test. Also, the first positive electrode active material layer 11b having a thickness of 3 μm was formed on a surface of the plate 14. Then, the second positive electrode active material layer 11c having a thickness of 50 nm was formed on the first positive electrode active material layer 11b. The lamination body of the first positive electrode active material layer 11b and the second positive electrode active material layer 11c was heated at 580° C. for ten minutes. This obtained a test piece of a second test. In the second test, the target containing LiCo_{0.9}Al_{0.1}O₂ as the main component was sputtered to form the second positive electrode active material layer 11c. The first test and the second test each underwent the Raman spectroscopic analysis with excitation light having a wavelength of 632.8 nm.

As illustrated in FIG. 7, in the first test, the peak at a Raman shift of 480 cm⁻¹ and the peak at a Raman shift of 590 cm⁻¹ were recognized as peaks derived from lithium cobalt oxide. In the same manner as the first test, in the second test, the peak at a Raman shift of 480 cm⁻¹ and the peak at a Raman shift of 590 cm⁻¹ were recognized as peaks derived from lithium cobalt oxide. Other peaks were not recognized.

That is, the first positive electrode active material layer 11b in the lamination body of the first positive electrode active material layer 11b and the second positive electrode active material layer 11c has the same crystal structure as the first positive electrode active material layer (i.e., first test) formed just by the first positive electrode active material layer 11b. Thus, it was confirmed that the first positive electrode active material layer 11b in the lamination body maintained a crystal structure that sufficiently functions as the positive electrode active material layer.

[Surface Structure After Heating]

The process for obtaining the first test was used to obtain a test piece of a third test. The process for obtaining the second test was used to obtain a test piece of a fourth test. A scanning electron microscope (SEM) was used to capture an image of the test piece of the third test to obtain an image of a surface of the first positive electrode active material layer 11b located at the side opposite to the side of the plate 14. Also, the SEM was used to capture an image of the test piece of the fourth test to obtain an image of a surface of the second positive electrode active material layer 11c located at the side opposite to the side of the first positive electrode active material layer 11b.

FIG. 8 illustrates the SEM image of the test piece of the third test. FIG. 9 illustrates the SEM image of the test piece of the fourth test.

As illustrated in FIG. 9, the fourth test confirmed that edges of the structural body formed on the surface of the second positive electrode active material layer 11c were sharp and had facets that were clearly shown. As illustrated in FIG. 8, the third test confirmed that edges of the structural body formed on the surface of the first positive electrode active material layer 11b were rounder than those of the fourth test.

The third test also confirmed that prior to the heating, the edge of the structural body formed on the surface of the first positive electrode active material layer 11b were as sharp as those of the fourth test illustrated in FIG. 9. Thus, formation of the second positive electrode active material layer 11c limits changes, which would be caused by the heating, in the structure of the surface of the positive electrode 11 defining the interface with the solid electrolyte layer 13.

Lithium cobalt oxide, which is the main component of the first positive electrode active material layer 11b, includes cobalt of a transition metal. Cobalt includes bivalent ions and trivalent ions. When lithium cobalt oxide is heated approximately to the temperature of the above heating step, the valence of cobalt tends to change. Thus, in the third test, when the valance of cobalt is changed in the surface of the first positive electrode active material layer 11b, which is most likely to be affected by the heating, lithium cobalt oxide may be changed to tricobalt tetroxide (Co₃O₄) or the like.

The main component of the second positive electrode active material layer 11c is LiCo₁₋ₓAlₓO₂, which contains aluminum that is more stable against heat than cobalt. Thus, in the fourth test, the second positive electrode active material in the surface of the second positive electrode active material layer 11c is hindered from changing into another material that has a different crystal structure.

[Internal Resistance of Thin Film Lithium-Ion Rechargeable Battery]

The positive electrode power collection layer 11a, the first positive electrode active material layer 11b, and the solid electrolyte layer 13, and the negative electrode power collection layer 12a were sequentially formed on the plate 14 through sputtering. Then, the negative electrode active material layer 12b was formed through vapor deposition. This obtained a fifth test of a thin film lithium-ion rechargeable battery. Additionally, after forming the first positive electrode active material layer 11b, the lamination body, which included the plate 14, the positive electrode power collection layer 11a, and the first positive electrode active material layer 11b, was heated. The positive electrode power collection layer 11a, the first positive electrode active material layer 11b, the solid electrolyte layer 13, the negative electrode power collection layer 12a, and the negative electrode active material layer 12b were formed with the materials and thicknesses described below.

Positive electrode power collection layer: titanium (thickness 0.02 μm), platinum (thickness 0.1 μm)

First positive electrode active material layer: lithium cobalt oxide (thickness 3 μm)
Solid electrolyte layer: lithium phosphorus oxynitride (thickness 2 μm)
Negative electrode power collection layer: chromium (thickness 0.02 μm), nickel (thickness 0.1 μm)
Negative electrode active material layer: lithium (thickness 2 μm)

A sixth test of a thin film lithium-ion rechargeable battery was obtained through the same process for obtaining the fifth test except that the second positive electrode active material layer 11c was formed between the first positive electrode active material 11b and the solid electrolyte layer 13. Further, after forming the second positive electrode active material layer 11c, a lamination body, which included the plate 14, the positive electrode power collection layer 11a, the first positive electrode active material layer 11b, and the second positive electrode active material layer 11c, was heated. The second positive electrode active material layer 11c was formed with the material and thickness described below.

Second positive electrode active material layer: lithium cobalt oxide containing aluminum (thickness 50 nm)

A target that contains LiCo_{0.9}Al_{0.1}O₂ as the main component was used to form the second positive electrode active material layer 11c.

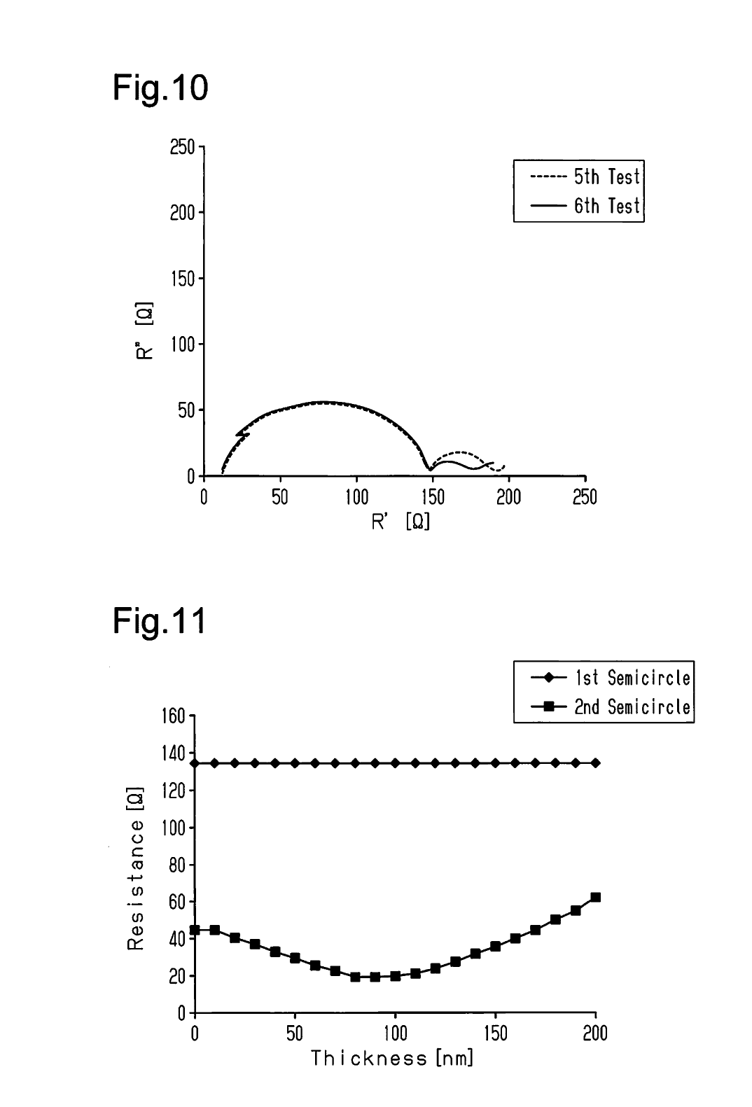

As illustrated in FIG. 10, the Cole-Cole plot curves confirmed that when a current used in the AC impedance measurement had a relatively high frequency, a first semicircle was obtained. It was also confirmed that when the current had a relatively low frequency, a second semicircle was obtained. The fifth test confirmed that the resistance of the first semicircle was 135 Ω and that the resistance of the second semicircle was 45 Ω. The sixth test confirmed that the resistance of the first semicircle was 135 Ω and that the resistance of the second semicircle was 30 Ω.

It is understood that the internal resistance of the thin film lithium-ion rechargeable battery is mainly the resistance caused by movement of lithium ions in the solid electrolyte layer and the resistance in the interface of the positive electrode and the solid electrolyte layer. When the thickness of the solid electrolyte layer is increased, the resistance of a first semicircle increases. Thus, the first semicircle represents the resistance caused by movement of lithium ions in the solid electrolyte layer. The resistance of a second semicircle is not observed in a lamination body that does not include the positive electrode. Additionally, the resistance of the second semicircle is not affected by the thickness of the solid electrolyte layer and the thickness of the positive electrode. Thus, the second semicircle represents the resistance in the interface of the positive electrode and the solid electrolyte layer.

Therefore, the graph of FIG. 10 shows that when the thin film lithium-ion rechargeable battery includes the second positive electrode active material layer 11c having the thickness of 50 nm, the resistance is decreased in the interface of the positive electrode 11 and the solid electrolyte layer 13.

[Relationship between Second Positive Electrode Active Material Layer Thickness and Thin Film Lithium-Ion Rechargeable Battery Performance]

The performance of the thin film lithium-ion rechargeable batteries was evaluated by changing the thickness of the second positive electrode active material layer 11c by 10 nm for each thin film lithium-ion rechargeable battery. The evaluated performance of the thin film lithium-ion rechargeable battery included the internal resistance, the discharge voltage obtained when discharging a constant current, and the discharge capacity obtained when discharging a constant current.

The thin film lithium-ion rechargeable battery that included the second positive electrode active material layer 11c having a thickness of 0 nm was obtained through the same process for obtaining the fifth test. Among the thin film lithium-ion rechargeable batteries obtained by changing the thickness of the second positive electrode active material layer 11c between 10 nm and 200 nm by 10 nm for each thin film lithium-ion rechargeable battery, the thin film lithium-ion rechargeable battery that included the second positive electrode active material layer 11c having a thickness of 50 nm was obtained through the same process for obtaining the sixth test. The thin film lithium-ion rechargeable battery that included the second positive electrode active material layer 11c having a thickness other than 0 nm and 50 nm was obtained through the same process for obtaining the sixth test except that the thickness of the second positive electrode active material layer 11c was changed.

[Internal Resistance]

The AC impedance process was used to measure the resistance of the first semicircle and the resistance of the second semicircle in each of the thin film lithium-ion rechargeable batteries that included the second positive electrode active material layers 11c of different thicknesses.

As illustrated in FIG. 11, when the thickness of the second positive electrode active material layer 11c is 0 nm or greater and 200 nm or less, the resistance of the first semicircle is 135 Ω. This confirmed that the resistance of the first semicircle did not change even when the thickness of the second positive electrode active material layer 11c changed.

It was confirmed that when the thickness of the second positive electrode active material layer 11c was 0 nm or greater and 10 nm or less, the resistance of the second semicircle was 45 Ω. It was also confirmed that when the thickness of the second positive electrode active material layer 11c was 80 nm or greater and 100 nm or less, the resistance of the second semicircle was 20 Ω. Additionally, it was confirmed that when the thickness of the second positive electrode active material layer 11c was 10 nm or greater and 80 nm or less, the resistance of the second semicircle decreased as the thickness of the second positive electrode active material layer 11c increased. Further, it was confirmed that when the thickness of the second positive electrode active material layer 11c was 80 nm or greater and 100 nm or less, the resistance of the second semicircle was maintained at the minimum value.

It was confirmed that when the thickness of the second positive electrode active material layer 11c was 200 nm, the resistance of the second semicircle was 62 Ω. It was also confirmed that when the thickness of the second positive electrode active material layer 11c was 100 nm or greater and 200 nm or less, the resistance of the second semicircle increased as the thickness of the second positive electrode active material layer 11c increased.

[Discharge Voltage and Discharge Capacity]

The discharge voltage and the discharge capacity were measured when the discharge current was substantially the maximum value of 9.0 mA. The discharge voltage and the discharge capacity were measured for thin film lithium-ion rechargeable batteries with second positive electrode active material layers 11c of different thicknesses from 0 nm to 100 nm, which were changed by 10 nm whenever measured. Each discharge voltage is the plateau voltage of the corresponding thin film lithium-ion rechargeable battery.

As illustrated in FIG. 12, it was confirmed that when the thickness of the second positive electrode active material layer 11c was 0 nm, the discharge voltage was 2.4 V. It was confirmed that when the thickness of the second positive electrode active material layer 11c was 20 nm, the discharge voltage was 2.7 V. It was also confirmed that when the thickness of the second positive electrode active material layer 11c was 0 nm or greater and 20 nm or less, the discharge voltage increased as the thickness of the second positive electrode active material layer 11c increased.

It was confirmed that when the thickness of the second positive electrode active material layer 11c was 30 nm or greater and 50 nm or less, the discharge voltage was maintained at 2.75 V. It was confirmed that when the thickness of the second positive electrode active material layer 11c was 60 nm, the discharge voltage was 2.7 V. Additionally, it was confirmed that when the thickness of the second positive electrode active material layer 11c was 20 nm or greater and 60 nm or less, the discharge voltage of the thin film lithium-ion rechargeable battery was substantially maintained at the maximum value.

It was confirmed that when the thickness of the second positive electrode active material layer 11c was 100 nm, the discharge voltage was 2.32 V. It was confirmed that when the thickness of the second positive electrode active material layer 11c was 60 nm or greater and 100 nm or less, the discharge voltage decreased as the thickness of the second positive electrode active material layer 11c increased.

Thus, it was confirmed that when the discharge current was substantially the maximum value, the second positive electrode active material layer 11c having the thickness of 20 nm or greater and 60 nm or less prior to the heating obtained higher discharge voltages than the second positive electrode active material layer 11c having other thicknesses. In other words, it was confirmed that when the second positive electrode active material layer 11c had the thickness of 20 nm or greater and 60 nm or less prior to the heating, the discharge current and the discharge voltage were both maintained at the maximum values and the output density of the thin film lithium-ion rechargeable battery was increased.

As described above with reference to FIG. 11, when the thickness of the second positive electrode active material layer 11c was 20 nm or greater and 60 nm or less prior to the heating, the resistance of the second semicircle, that is, the resistance in the interface of the positive electrode 11 and the solid electrolyte layer 13, decreased as the thickness of the second positive electrode active material layer 11c increased. Thus, it is determined that a decrease in the resistance in the interface of the positive electrode 11 and the solid electrolyte layer 13 is a factor that increases the discharge voltage of the thin film lithium-ion rechargeable battery.

Additionally, as illustrated in FIG. 12, it was confirmed that when the thickness of the second positive electrode active material layer 11c was 0 nm or greater and 30 nm or less, the discharge capacity was maintained at 130 μAh when discharging a high current. It was confirmed that when the thickness of the second positive electrode active material layer 11c was 100 nm, the discharge capacity was 60 μAh. It was also confirmed that when the thickness of the second positive electrode active material layer 11c was 30 nm or greater and 100 nm or less, the discharge capacity decreased as the thickness of the second positive electrode active material layer 11c increased.

Therefore, it was confirmed that when the second positive electrode active material layer 11c had the thickness of 20 nm or greater and 30 nm or less prior to the heating, the discharge capacity was maintained at a large value while substantially maintaining both the discharge current and the discharge voltage at the maximum values.

[Counter Diffusion Caused by Heating]

The first positive electrode active material layer 11b and the second positive electrode active material layer 11c were laminated on a surface of the plate 14. Then, the lamination body, which includes the plate 14, the first positive electrode active material layer 11b, and the second positive electrode active material layer 11c, was heated to obtain a test piece of a seventh test. Prior to the heating, the thickness of the first positive electrode active material layer 11b was set to 3 μm, and the thickness of the second positive electrode active material layer 11c was set to 100 nm.

FIG. 13 illustrates the X-ray intensity of oxygen atoms, the X-ray intensity of aluminum atoms, and the X-ray intensity of cobalt atoms in a portion that partially includes the second positive electrode active material layer 11c and the first positive electrode active material layer 11b that were measured using an STEM-EDX along a measurement line L. In FIG. 13, the right end of the measurement line L corresponds to the position of the outermost surface of the second positive electrode active material layer 11c, that is, the surface opposite to the surface contacting the first positive electrode active material layer 11b. The X-ray intensity of each atom is the intensity of the characteristic X-ray derived from the atom.

As illustrated in FIG. 13, it was confirmed that the intensity of the characteristic X-ray of cobalt atoms and the intensity of the characteristic X-ray of aluminum atoms along the measurement line L were each maintained at a substantially constant intensity to a depth of 80 nm from the outermost surface of the second positive electrode active material layer 11c.

It was also confirmed that as the depth increased in a range of 80 nm to 120 nm from the outermost surface of the second positive electrode active material layer 11c, the intensity of the characteristic X-ray of cobalt atoms gradually increased, whereas the intensity of the characteristic X-ray of aluminum atoms gradually decreased. This indicates that in the depth of 80 nm to 120 nm, aluminum atoms and cobalt atoms performed counter diffusion in the vicinity of the interface of the first positive electrode active material layer 11b and the second positive electrode active material layer 11c. It was confirmed that the intensity of the characteristic X-ray of oxygen atoms was substantially constant throughout the depth of 0 nm to 120 nm.

Thus, it was confirmed that when the first positive electrode active material layer 11b and the second positive electrode active material layer 11c were heated, a counter diffusion layer having a thickness of 40 nm was formed in the second positive electrode active material layer 11c. More specifically, it was confirmed that when heated, some of the aluminum atoms, which were contained in the second positive electrode active material layer 11c, were diffused toward the first positive electrode active material layer 11b over 20 nm from the second positive electrode active material layer 11c. Further, some of the cobalt atoms, which were contained in the first positive electrode active material layer 11b, were diffused toward the second positive electrode active material layer 11c over 20 nm from the first positive electrode active material layer 11b.

Therefore, the thickness of the second positive electrode active material layer 11c subsequent to the heating, that is, the second positive electrode active material layer 11c including aluminum and lithium cobalt oxide, is increased just by 20 nm from the thickness prior to the heating.

When the outermost surface of the second positive electrode active material layer 11c is referred to as a first surface, and the surface of the second positive electrode active material layer 11c that is in contact with the first positive electrode active material layer 11b (i.e., surface opposite to first surface) is referred to as a second surface, the second positive electrode active material layer 11c includes a first portion having the first surface and a second portion having the second surface. The first portion corresponds to a portion in which the characteristic X-ray of cobalt atoms and the characteristic X-ray of aluminum atoms are each maintained at a substantially constant intensity. The second portion corresponds to a portion in which the intensity of the characteristic X-ray of cobalt atoms gradually increases in a depth-wise direction, which extends toward the second surface from the first surface, whereas the intensity of the characteristic X-ray of aluminum atoms gradually decreases in the depth-wise direction. More specifically, the second portion corresponds to the counter diffusion layer. In the present example, the second portion is formed to have a thickness of 40 nm. In the second positive electrode active material layer 11c having such a structure, the first portion has a higher concentration of aluminum atoms than the second portion.

The embodiment has the advantages described below.

(1) In the step of forming the second positive electrode active material layer 11c, the second positive electrode active material layer 11c having the thickness of 20 nm or greater and 60 nm or less is formed to cover the first positive electrode active material layer 11b. This increases the output density of the thin film lithium-ion rechargeable battery 10.

(2) In the step of forming the second positive electrode active material layer 11c, the second positive electrode active material layer 11c having the thickness of 20 nm or greater and 30 nm or less is particularly formed. This increases the output density of the thin film lithium-ion rechargeable battery 10 while limiting decreases of the discharge capacity.

(3) In the step of forming the second positive electrode active material layer 11c, when the total of the number of aluminum atoms and the number of cobalt atoms is set to one, the second positive electrode active material layer 11c is formed so that the number of aluminum atoms is 0.05 or greater and less than 0.5. When the number of aluminum atoms is 0.05 or greater, the second positive electrode active material layer 11c has a higher thermal resistance than the first positive electrode active material layer 11b. When the number of aluminum atoms is less than 0.5, the crystal structure of the second positive electrode active material layer 11c does not greatly differ from that of the first positive electrode active material layer 11b.

(4) In the thin film lithium-ion rechargeable battery 10, the positive electrode 11 includes the second positive electrode active material layer 11c having the thickness of 40 nm or greater and 80 nm or less. This structure increases the output density of the thin film lithium-ion rechargeable battery 10.

It should be apparent to those skilled in the art that the foregoing embodiments may be employed in many other specific forms without departing from the scope of this disclosure. Particularly, it should be understood that the foregoing embodiments may be employed in the following forms.

In addition to the positive electrode 11, the negative electrode 12, the solid electrolyte layer 13, and the plate 14, the thin film lithium-ion rechargeable battery 10 may further include a seal layer that covers the positive electrode 11, the negative electrode 12, and the solid electrolyte layer 13.

The positive electrode 11 may include a further layer other than the positive electrode power collection layer 11a, the first positive electrode active material layer 11b, and the second positive electrode active material layer 11c. In this case, when the further layer is formed before the first positive electrode active material layer 11b and the second positive electrode active material layer 11c in the step of forming the positive electrode 11, the lamination body including the further layer, the positive electrode power collection layer 11a, the first positive electrode active material layer 11b, and the second positive electrode active material layer 11c may be heated in the heating step. When the further layer is formed after the first positive electrode active material layer 11b and the second positive electrode active material layer 11c, if the further layer needs to be heated, the further layer may be heated together with the positive electrode power collection layer 11a, the first positive electrode active material layer 11b, and the second positive electrode active material layer 11c in the heating step.

When the total of the number of aluminum atoms and the number of cobalt atoms is set to one, the second positive electrode active material layer 11c may include a portion in which the number of aluminum atoms is 0.05 or greater and less than 0.5. Even in this case, at least advantage (3) is obtained in the portion of the second positive electrode active material layer 11c where the number of aluminum atoms is 0.05 or greater and less than 0.5.

When the total of the number of aluminum atoms and the number of cobalt atoms is set to one, the number of aluminum atoms may be less than 0.05. Even in such a configuration, advantage (1) is obtained as long as the second positive electrode active material layer 11c is formed by LiCo₁₋ₓAlₓO₂ and the thickness of the second positive electrode active material layer 11c is 20 nm or greater and 60 nm or less.

When the total of the number of aluminum atoms and the number of cobalt atoms is set to one, the number of aluminum atoms may be 0.5 or greater. Even in such a configuration, advantage (1) is obtained as long as the second positive electrode active material layer 11c is formed by LiCo₁₋ₓAlₓO₂ and the thickness of the second positive electrode active material layer 11c is 20 nm or greater and 60 nm or less.

As described above, to limit decreases in the discharge capacity of the thin film lithium-ion rechargeable battery 10, it is preferred that the thickness of the second positive electrode active material layer 11c be 20 nm or greater and 30 nm or less prior to the heating. However, advantage (1) is also obtained when the thickness is 30 nm or greater and 60 nm or less.

The material forming the first positive electrode active material layer 11b may contain a material other than lithium cobalt oxide as long as at least 95 mass percent of the main component of the first positive electrode active material is lithium cobalt oxide and the function of the positive electrode active material layer is maintained.

The material forming the second positive electrode active material layer 11c may contain a material other than lithium cobalt oxide and aluminum as long as at least 95 mass percent of the main component of the second positive electrode active material is LiCo₁₋ₓAlₓO₂ (cobalt of lithium cobalt oxide is partially replaced with aluminum) and the function of the positive electrode active material layer is maintained.

The negative electrode 12 may include a further layer in addition to the negative electrode power collection layer 12a and the negative electrode active material layer 12b.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to an illustration of the superiority and inferiority of the invention. Although embodiments have been described in detail, it should be understood that various changes, substitutions, and alterations could be made hereto without departing from the scope of this disclosure.

1. A method for forming a positive electrode for a thin film lithium-ion rechargeable battery, the method comprising:
forming a positive electrode power collection layer;
forming a first positive electrode active material layer by covering the positive electrode power collection layer with a first positive electrode active material that contains lithium cobalt oxide;
forming a second positive electrode active material layer that has a thickness of 20 nm or greater and 60 nm or less by covering the first positive electrode active material layer with a second positive electrode active material that contains aluminum and lithium cobalt oxide; and
heating a lamination body that includes the positive electrode power collection layer, the first positive electrode active material layer, and the second positive electrode active material layer.

2. The method according to claim 1, wherein the forming a second positive electrode active material layer includes forming the second positive electrode active material layer that has a thickness of 20 nm or greater and 30 nm or less.

3. The method according to claim 1, wherein the forming a second positive electrode active material layer includes forming the second positive electrode active material layer so that when a total of the number of aluminum atoms and the number of cobalt atoms is set to one, the number of the aluminum atoms is 0.05 or greater and less than 0.5 in at least a portion of the second positive electrode active material layer.

4. The method according to claim 1, wherein
the heating a lamination body includes heating the lamination body so that the second positive electrode active material layer has a thickness of 40 nm or greater and 80 nm or less subsequent to the heating,
the second positive electrode active material layer subsequent to the heating includes a counter diffusion layer located at an interface of the first positive electrode active material layer and the second positive electrode active material layer, and
the counter diffusion layer is formed by diffusing aluminum atoms from the second positive electrode active material layer toward the first positive electrode active material layer and diffusing cobalt atoms from the first positive electrode active material layer toward the second positive electrode active material layer.

5. A positive electrode for a thin film lithium-ion rechargeable battery, the positive electrode comprising:
a positive electrode power collection layer including a cover surface;
a first positive electrode active material layer formed from a first positive electrode active material that contains lithium cobalt oxide, wherein the first positive electrode active material layer includes a first surface, which faces the cover surface of the positive electrode power collection layer, and a second surface, which is opposite to the first surface; and
a second positive electrode active material layer formed from a second positive electrode active material that contains aluminum and lithium cobalt oxide, wherein the second positive electrode active material layer has a thickness of 40 nm or greater and 80 nm or less and covers and contacts the second surface of the first positive electrode active material layer.

6. The positive electrode according to claim 5, wherein the second positive electrode active material layer includes a counter diffusion layer located at an interface of the first positive electrode active material layer and the second positive electrode active material layer, wherein the counter diffusion layer includes aluminum atoms diffused from the second positive electrode active material layer toward the first positive electrode active material layer and cobalt atoms diffused from the first positive electrode active material layer toward the second positive electrode active material layer.

7. A thin film lithium-ion rechargeable battery comprising:
the positive electrode according to claim 5;
a negative electrode; and
a solid electrolyte layer located between the positive electrode and the negative electrode,
wherein the first positive electrode active material layer and the second positive electrode active material layer are located between the positive electrode power collection layer and the solid electrolyte layer.
